(19) United States
(12) Patent Application Publication
(10) Pub. No.: US 2013/0092617 A1
(43) Pub. Date: Apr. 18, 2013

(54) WATER TREATMENT UNIT AND WATER TREATMENT APPARATUS

(71) Applicant: SUMITOMO ELECTRIC INDUSTRIES, LTD., Osaka (JP)

(72) Inventors: Hideki KASHIHARA, Osaka (JP); Munetsugu UEYAMA, Osaka (JP); Shuji HAHAKURA, Osaka (JP); Satoshi YAHAGI, Osaka (JP); Ryusuke NAKAI, Osaka (JP)

(73) Assignee: SUMITOMO ELECTRIC INDUSTRIES, LTD., Osaka (JP)

(21) Appl. No.: 13/648,456

(22) Filed: Oct. 10, 2012

Related U.S. Application Data
(60) Provisional application No. 61/546,751, filed on Oct. 13, 2011.

(30) Foreign Application Priority Data
Oct. 13, 2011 (JP) 2011-225558

(51) Int. Cl. C02F 1/44; B01D 63/00

(52) U.S. Cl. 210/321.63

(57) ABSTRACT

A water treatment unit is usable in a water treatment apparatus that performs water treatment using a reverse osmosis membrane. The water treatment unit includes: a casing; a separation membrane mounted in the casing and bent into a pleated shape; a reinforcing member attached to the separation membrane and having a function of reinforcing the separation membrane; a rotating mechanism rotating the separation membrane; and a cleaning device capable of cleaning the separation membrane. The separation membrane has a plurality of island-like portions and a plurality of fiber-like portions extending from the island-like portions and having a width smaller than that of the island-like portions, and an area of the fiber-like portions at a membrane surface is set to be larger than that of the island-like portions.

### BACKGROUND OF THE INVENTION

1. Field of the Invention

The present invention relates to a water treatment unit and a water treatment apparatus including the water treatment unit.

2. Description of the Background Art

A water treatment apparatus using a reverse osmosis membrane has been conventionally known. When seawater is desalinated with this type of water treatment apparatus, pretreatment for removing suspended substances or organic particles such as TEP (Transparent Exopolymer Particles) from raw water is typically performed before treatment with the reverse osmosis membrane.

One example of a pretreatment apparatus usable in this pretreatment is described in, for example, Japanese Patent No. 4525857.

According to the pretreatment apparatus described in Japanese Patent No. 4525857, a large amount of treatment can be obtained with small installation area, and the organic particles can also be effectively removed. As schematically shown in FIG. 5, a separation membrane used in the pretreatment apparatus described in Japanese Patent No. 4525857 mainly includes an island-like node 5 and an ultrathin fiber-like fibril 6 connecting nodes 5.

The inventors of the present application earnestly studied a structure of the separation membrane that can effectively remove, in the pretreatment, saccharide and particularly saccharide swelled with water and jellified like TEP. As a result of their study, the inventors of the present application found that a ratio between nodes 5 and fibrils 6 affects a saccharide removal rate.

### SUMMARY OF THE INVENTION

Thus, an object of the present invention is to provide a water treatment unit and a water treatment apparatus (water treatment system) in which a separation membrane having an adjusted ratio between nodes (island-like portions) and fibrils (fiber-like portions) is used and thereby a rate of removal of saccharide from water to be treated can be enhanced.

A water treatment unit according to the present invention is usable in a water treatment apparatus that performs water treatment using a reverse osmosis membrane. The water treatment unit includes: a casing; a separation membrane mounted in the casing and bent into a pleated shape; a reinforcing member attached to the separation membrane and having a function of reinforcing the separation membrane; a rotating mechanism rotating the separation membrane; and a cleaning device capable of cleaning the separation membrane. The separation membrane has a plurality of island-like portions and a plurality of fiber-like portions extending from the island-like portions and having a width smaller than that of the island-like portions, and an area of the fiber-like portions at a membrane surface is set to be larger than that of the island-like portions.

Preferably, a thickness of the reinforcing member is set to be larger than that of the separation membrane, and a water permeability of the reinforcing member is set to be larger than that of the separation membrane. The separation membrane can be formed of, for example, a hydrophobic membrane, and the reinforcing member can be formed of at least one type selected from a metal mesh member, non-woven fabric and woven fabric.

Preferably, a rate of removal of saccharide from water to be treated is 50% or more. Preferably, the area of the fiber-like portions at the membrane surface of the separation membrane is set to be five times or more of that of the island-like portions.

Preferably, the cleaning device includes at least one of cleaning liquid supply means capable of supplying a cleaning liquid into the casing, ultrasonic wave supply means capable of supplying an ultrasonic wave to the separation membrane, and water flow/bubble flow supply means capable of supplying a water flow and/or a bubble flow to the separation membrane.

A water treatment apparatus (water treatment system) according to the present invention performs water treatment using a reverse osmosis membrane. The water treatment apparatus includes: a first water treatment unit capable of performing pretreatment of water to be treated; and a second water treatment unit capable of performing main treatment of the water to be treated. The first water treatment unit includes: a casing; a separation membrane mounted in the casing and bent into a pleated shape; a reinforcing member attached to the separation membrane and having a function of reinforcing the separation membrane; a rotating mechanism rotating the separation membrane; and a cleaning device capable of cleaning the separation membrane. The separation membrane has a plurality of island-like portions and a plurality of fiber-like portions extending from the island-like portions and having a width smaller than that of the island-like portions, and an area of the fiber-like portions at a membrane surface is set to be larger than that of the island-like portions.

The inventors of the present application learned that by setting the area of the fiber-like portions at the membrane surface of the separation membrane to be larger than that of the island-like portions, i.e., configuring the separation membrane to be mainly composed of the fiber-like portions, the rate of removal of saccharide from the water to be treated can be enhanced. Since such a separation membrane is used in the water treatment unit and the water treatment apparatus (water treatment system) according to the present invention, the rate of removal of saccharide from the water to be treated can be enhanced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a water treatment apparatus (water treatment system) according to an embodiment of the present invention.

FIG. 2 is a cross-sectional view showing a water treatment unit according to the embodiment of the present invention.

FIG. 3(a) is a cross-sectional view taken along line in FIG. 2 and FIG. 3(b) is an enlarged view of a nozzle and a neighboring region in the cross-sectional view shown in FIG. 3(a).

FIG. 4 is a partially enlarged photograph of a surface of a separation membrane according to the embodiment of the present invention.

FIG. 5 is a schematic view showing a structural example of a part of a surface of a conventional separation membrane.

### DESCRIPTION OF THE PREFERRED EMBODIMENTS

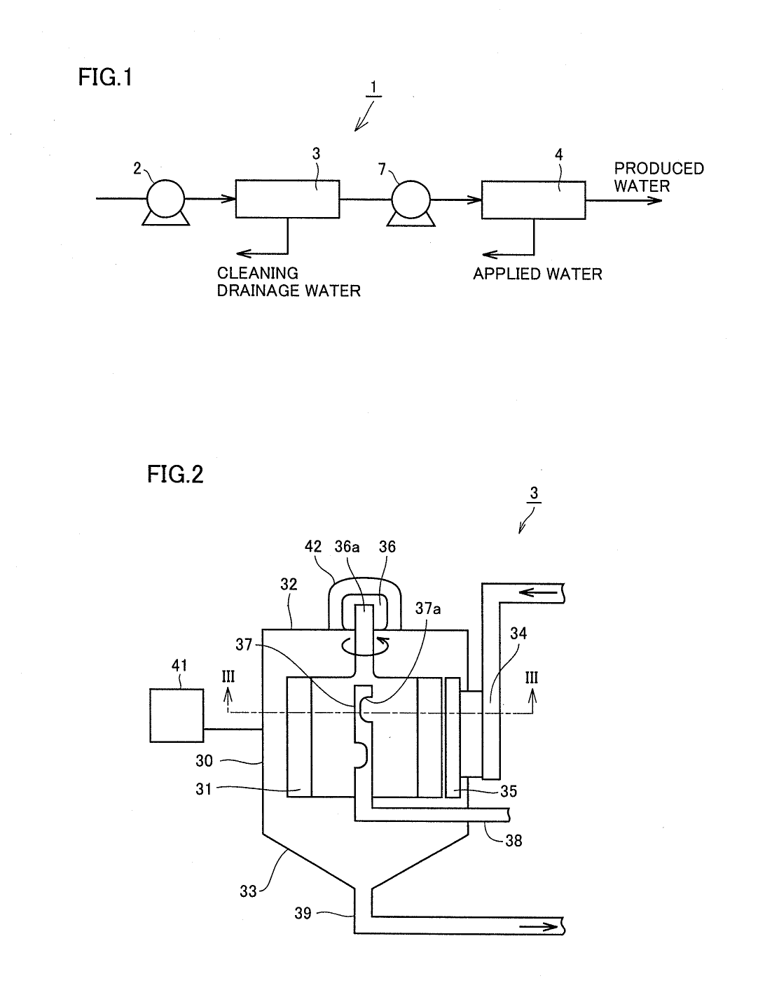

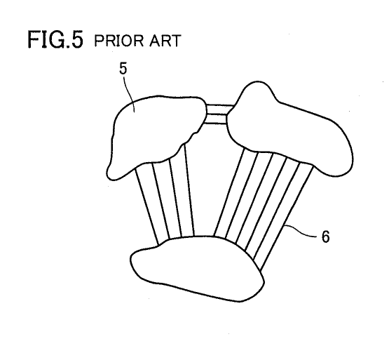

An embodiment of the present invention will be described hereinafter with reference to FIGS. 1 to 5.

A water treatment apparatus (water treatment system) 1 according to the present embodiment is an apparatus that performs water treatment using a reverse osmosis membrane. Water treatment apparatus 1 can be used to treat water such as seawater, groundwater and discharged water that contains various impurities, and is useful for seawater desalination treatment.

As shown in FIG. 1, water treatment apparatus 1 includes a pump 2, a first water treatment unit 3 capable of performing pretreatment of water to be treated, a second water treatment unit 4 capable of performing main treatment of the water to be treated, and a pump 7 providing backwater to the reverse osmosis membrane under high pressure. Pump 2 is arranged in the former stage of first water treatment unit 3, and pump 2 delivers the water to be treated (produced water) in the direction shown by an arrow in the figure.

In water treatment apparatus 1 shown in FIG. 1, seawater, for example, is delivered into first water treatment unit 3 and passes through a separation membrane (filtration membrane) in first water treatment unit 3, and thereby the pretreatment is performed. As a result, organic particles and inorganic solids in the seawater are filtered and removed. The seawater that has been subjected to the pretreatment as described above is delivered into second water treatment unit 4 and passes through the reverse osmosis membrane (not shown) in second water treatment unit 4, and thereby desalting is performed. As a result, fresh water can be obtained from the seawater. First water treatment unit 3 may be configured by a single unit or a plurality of units. In other words, a configuration of one-stage filtration may be used or a configuration of multiple-stage filtration in which filtration of two or more stages is performed may be used. For example, when two-stage filtration is used, it is conceivable to perform first filtration using a separation membrane having an average pore diameter of approximately several micrometers and second filtration using Microfiltration (MF) or Ultrafiltration (UF).

As shown in FIG. 2, first water treatment unit 3 includes a casing 30, a separation membrane 31 mounted in casing 30 and bent into a pleated shape, a reinforcing member attached to separation membrane 31 and having a function of reinforcing separation membrane 31, a rotating mechanism 42 rotating the separation membrane, and a cleaning device 41 attached to casing 30 and capable of cleaning separation membrane 31. Although hollow fibers and a membrane can be both used as separation membrane 31, the case where the membrane is used will now be described.

Casing 30 has, for example, a rectangular or cylindrical shape and can be made of any material as long as it has the required mechanical strength. Casing 30 has a lid portion 32, a sidewall portion and a tapered bottom portion 33. In the example in FIG. 2, rotating mechanism 42 capable of rotating separation membrane 31 is attached to lid portion 32, and a discharge flow channel 39 is provided at bottom portion 33. A water-to-be-treated flow channel 34 for introducing seawater, which is the water to be treated, into casing 30 is connected to the sidewall portion of casing 30. A nozzle 35 is connected to an end of water-to-be-treated flow channel 34. Nozzle 35 is arranged within casing 30 such that an opening of nozzle 35 faces an outer circumferential surface of separation membrane 31. Although the shape of the opening can be arbitrarily set, the opening has a rectangular shape in the example in FIG. 2. In addition, the length of nozzle 35 in the vertical direction in FIG. 2 may be different from the axial length of separation membrane 31, or these lengths may be nearly equal as shown in FIG. 2. Through this nozzle 35, the water to be treated that has been supplied from water-to-be-treated flow channel 34 can be jetted toward separation membrane 31. On the other hand, through discharge flow channel 39, unnecessary liquid such as untreated seawater remaining in casing 30 can be discharged.

In the example in FIG. 2, rotating mechanism 42 has a motor 36 and a rotation shaft 36a extending from the motor. Rotation shaft 36a is connected to separation membrane 31 by a connecting member, so that motive power from motor 36 can be transmitted through this rotation shaft 36a to separation membrane 31 to rotate separation membrane 31 clockwise or counterclockwise.

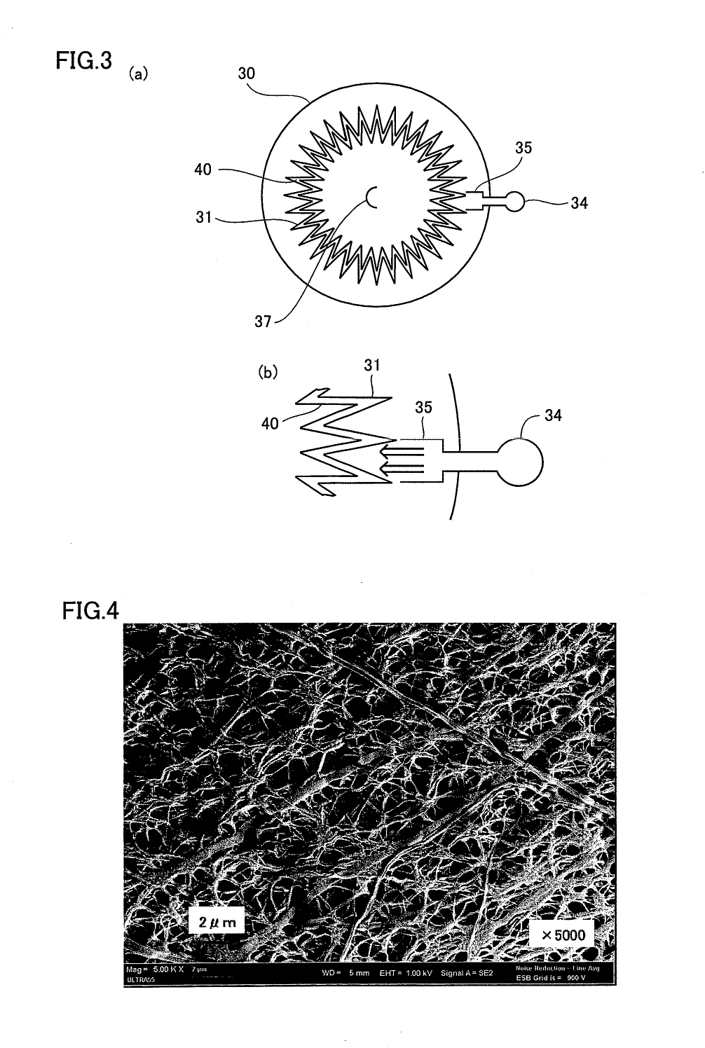

As shown in FIG. 3(a), separation membrane 31 has an annular shape and is mounted in casing 30 to be rotatable by rotating mechanism 42. An isolating member for isolating an internal space surrounded by separation membrane 31 from a surrounding space in casing 30 in a watertight manner is placed on the upper and lower surfaces of separation membrane 31. A central pipe 37 is disposed to extend into the internal space surrounded by separation membrane 31. Central pipe 37 has an intake hole 37a and is connected to a filtered water flow channel 38 through which the filtered water filtered by separation membrane 31 flows.

Separation membrane 31 can be made of, for example, a hydrophobic polymer material such as fluorine resin and polyolefin. Fluorine resin can include polytetrafluoroethylene (PTFE), polyvinylidene fluoride (PVDF) and the like, and polyolefin can include polyethylene, other poly-a-olefin and the like. Particularly by using PTFE, there can be obtained a membrane having a highly-developed fibril structure. Separation membrane 31 may have a thickness of, for example, approximately 500 μm or less.

As shown in FIG. 4, separation membrane 31 used in water treatment apparatus 1 according to the present embodiment includes a node that is an island-like portion and a fiber-like fibril extending from the node and having a width smaller than that of the node. In the example in FIG. 4, there are many nodes and fibrils, and some nodes extend long in a linear manner or in a curved manner. In the present invention, it is defined that the concept of the aforementioned “island-like portion” includes such nodes extending long in a linear manner or in a curved manner as well.

In separation membrane 31, an area of the fibrils (fiber-like portions) at a membrane surface shown in, for example, FIG. 4 is set to be larger than that of the nodes (island-like portions). In other words, separation membrane 31 is configured to be mainly composed of the fibrils. Preferably, the area of the fibrils is set to be three times or more, and more preferably five times or more, of that of the nodes. In the example in FIG. 4, the area of the fibrils is about five times as large as that of the nodes. Since separation membrane 31 is configured to be mainly composed of the fibrils as described above, the rate of removal of saccharide from the water to be treated can be enhanced. For example, by appropriately adjusting the area of the fibrils and the area of the nodes at the surface of separation membrane 31, the rate of removal of saccharide from the water to be treated can be 50% or more. It is to be noted that the areas of the fibrils and the nodes may be measured, for example, on a taken microscope photograph of the surface of separation membrane 31.

As shown in FIG. 4, separation membrane 31 has many minute holes and these holes have an average pore diameter of, for example, 1 to 10 μm, and more preferably 2 to 5 μm. “Average pore diameter of separation membrane 31” herein refers to a pore diameter determined by the bubble point method (airflow method). Specifically, this pore diameter refers to diameter d (μm) indicated by d=4Bγ/P, assuming that P (Pa) represents an IPA bubble point value (pressure) measured based on ASTM F316 by using isopropyl alcohol, γ represents the surface tension (dynes/cm) of the liquid, and B represents the capillary constant.

Next, a method for manufacturing aforementioned separation membrane 31 will be described. It is to be noted that a method for manufacturing separation membrane 31 made of PTFE will be described below.

For example, PTFE powders are prepared by emulsion polymerization and these powders are shaped into a membrane by extrusion. Thereafter, the membrane thus obtained is stretched and subjected to heat treatment. Separation membrane 31 can thus be manufactured. At this time, by appropriately adjusting conditions of extrusion and stretching of the PTFE powders, the average pore diameter, the mechanical strength and the like of separation membrane 31 can be adjusted. In addition, by adjusting conditions of the particle size, extrusion, stretching, and heat treatment of the PTFE powders, a ratio between the area of the fibrils and the area of the nodes can also be adjusted.

As shown in FIG. 3(a), reinforcing member 40 is attached to the inner side of separation membrane 31. Since this reinforcing member 40 can reinforce separation membrane 31, the shape of separation membrane 31 can be maintained. This may also contribute to enhancement of the rate of removal of saccharide from the water to be treated. Although reinforcing member 40 is attached to the entire back surface of separation membrane 31 in the present embodiment, reinforcing member 40 can also be selectively placed on the back surface of separation membrane 31. Reinforcing member 40 can also have a grid-like shape, for example. In addition, although one reinforcing member 40 is attached in the present embodiment, a plurality of reinforcing members 40 may also be attached to separation membrane 31. In addition, grid-like reinforcing member 40 that does not inhibit the permeation performance of separation membrane 31 may be incorporated into the surface of separation membrane 31.

A thickness of reinforcing member 40 is preferably set to be larger than that of separation membrane 31. As a result, separation membrane 31 can be effectively reinforced. As to water permeability, however, a water permeability of reinforcing member 40 is preferably set to be larger than that of separation membrane 31. As a result, even when reinforcing member 40 is provided, an amount of the water to be treated that passes through separation membrane 31 can be ensured. Reinforcing member 40 can be formed of at least one type selected from, for example, a metal mesh member, non-woven fabric and woven fabric.

In order to obtain separation membrane 31 and reinforcing member 40 having the shape shown in FIG. 2 and FIGS. 3(a) and 3(b), separation membrane 31 may be fabricated in accordance with the aforementioned method, reinforcing member 40 formed of, for example, non-woven fabric and having the same size as that of separation membrane 31 may be prepared separately, separation membrane 31 and reinforcing member 40 may be laid one on top of the other and joined each other, the whole of joined separation membrane 31 and reinforcing member 40 may be folded a plurality of times, and then, ends of these may be joined.

As shown in FIG. 3(b), the water to be treated passes through water-to-be-treated flow channel 34, is jetted from the opening of nozzle 35, and impinges on the outer circumferential surface of separation membrane 31 as a jet water flow. A part of the water to be treated passes through separation membrane 31 and reaches the internal space surrounded by reinforcing member 40. At this time, the water to be treated is filtered by separation membrane 31. Separation membrane 31 is rotationally driven by rotating mechanism 42 at a rotation speed of, for example, approximately 50 rpm and the other part of the water to be treated (untreated water) flows through casing 30 in the same direction as the rotational direction of separation membrane 31. Separation membrane 31 is cleaned by the jet water flow from nozzle 35. In other words, in the water treatment unit according to the present embodiment, the water to be treated can be filtered while the surface of separation membrane 31 is cleaned. The untreated water that has not been filtered, suspended substances that have precipitated in casing 30, and the like are sequentially discharged through discharge flow channel 39 provided at the bottom of casing 30. On the other hand, the filtered water that has been filtered by separation membrane 31 is guided through intake hole 37a of central pipe 37 to filtered water flow channel 38 and is discharged outside first water treatment unit 3.

Cleaning device 41 can include, for example, cleaning liquid supply means (not shown) capable of supplying a cleaning liquid into casing 30, ultrasonic wave supply means (not shown) capable of supplying an ultrasonic wave to separation membrane 31, water flow/bubble flow supply means (not shown) capable of supplying a water flow and/or a bubble flow to separation membrane 31, and the like. The water flow/bubble flow supply means can supply, for example, a jet water flow, a jet water flow including bubbles, and the like. These means may be used alone or in combination. The number and the placement position of these means can also be selected arbitrarily.

A well-known configuration can be used as the cleaning liquid supply means as long as it can supply the cleaning liquid into casing 30. Hypochlorous acid, a surfactant and the like can be used as the cleaning liquid, and particularly limonene (d-limonene: see the chemical formula 1 below)-containing water can be used, for example. Approximately 30 ppm to 1000 ppm of the limonene-containing water is, for example, supplied to an inner region of separation membrane 31 to remove TEP, suspended substances and the like with which the membrane is clogged due to backwash. By supplying the limonene-containing water to the inner region of separation membrane 31 and doing backwash of separation membrane 31 as described above, clogging of separation membrane 31 can be effectively removed. Particularly, TEP entangled in the membrane can be floated and effectively removed.

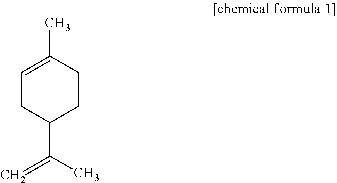

After the backwash with the limonene-containing water, rinse treatment with a slightly acidic solution such as a citric acid aqueous solution and an acetic acid aqueous solution or an alcohol solution such as an isopropyl alcohol aqueous solution and an ethanol aqueous solution is preferably performed. As a result, the quality of the water to be treated after the aforementioned backwash can be improved. Specifically, a value of SDI (Silt Density Index) can be decreased.

A well-known ultrasonic wave generating apparatus such as an ultrasonic vibrator can be used as the ultrasonic wave supply means. Ultrasonic waves (e.g., approximately 15 to 400 kHz) from the ultrasonic wave generating apparatus may be indirectly applied to separation membrane 31 through the water to be treated and the separation membrane elements in casing 30, or may be directly applied to separation membrane 31.

The water flow/bubble flow supply means can include various equipment and devices such as a nozzle capable of jetting a water flow and/or a bubble flow. A plurality of the water flow/bubble flow supply means may be arranged, for example, around separation membrane 31.

In water treatment apparatus 1 according to the present embodiment, second water treatment unit 4 performs desalting treatment. Second water treatment unit 4 includes the reverse osmosis membrane having a pore diameter of approximately 1 to 2 nm. The reverse osmosis membrane may be configured into a spiral-type or a tubular-type reverse osmosis membrane and may be formed of a hollow fiber membrane. Preferably, however, the reverse osmosis membrane has a structure that can treat a large amount of seawater.

Next, a method for measuring an amount of saccharide (saccharide amount) in the water to be treated will be described.

The saccharide amount can be measured by liquid chromatography of the concentrated water to be treated. Specifically, the saccharide amount can be determined based on a peak strength of saccharide of a chromatogram obtained by concentrating the water to be treated and hydrolyzing the obtained concentrated sample, and thereafter, analyzing the sample by liquid chromatography and particularly ion chromatography. The water to be treated can be concentrated using, for example, a method for remelting, with a small amount of pure water, the residue obtained after distilling away the water in the water to be treated and freeze-drying the water to be treated.

When ion chromatography is used, hydrolysis for changing polysaccharide in the water to be treated to monosaccharide is performed before determination by liquid chromatography. Filtration and centrifugal separation for removing suspended substances in the water to be treated, treatment with an ion-exchange resin for removing ions dissolved in the water to be treated, and the like may also be performed as other pretreatment.

In the case of ion chromatography with an anion-exchange resin, a mobile phase can include a sodium hydroxide solution and the like. Although a detector can include a differential refractometer and the like, an electrochemical detector is preferably used in the case of ion chromatography.

In the specification of the present application, “amount of saccharide (saccharide amount)” refers to a total amount of a rhamnose amount, a galactose amount, a glucose amount, and a mannose amount. “Saccharide removal rate” refers to a rate of decrease of a total amount of measurement values of a rhamnose amount, a galactose amount, a glucose amount, and a mannose amount with respect to “seawater (water to be treated)”.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A water treatment unit usable in a water treatment apparatus that performs water treatment using a reverse osmosis membrane, comprising:
a casing;
a separation membrane mounted in said casing and bent into a pleated shape;
a reinforcing member attached to said separation membrane and having a function of reinforcing said separation membrane;
a rotating mechanism rotating said separation membrane; and
a cleaning device capable of cleaning said separation membrane, wherein
said separation membrane has a plurality of island-like portions and a plurality of fiber-like portions extending from said island-like portions and having a width smaller than that of said island-like portions, and an area of said fiber-like portions at a membrane surface is set to be larger than that of said island-like portions.

2. The water treatment unit according to claim 1, wherein
a thickness of said reinforcing member is set to be larger than that of said separation membrane, and
a water permeability of said reinforcing member is set to be larger than that of said separation membrane.

3. The water treatment unit according to claim 1, wherein
said separation membrane is formed of a hydrophobic membrane, and
said reinforcing member is formed of at least one type selected from a metal mesh member, non-woven fabric and woven fabric.

4. The water treatment unit according to claim 1, wherein
the area of said fiber-like portions at the membrane surface of said separation membrane is set to be three times or more of that of said island-like portions.

5. The water treatment unit according to claim 1, wherein
a rate of removal of saccharide from water to be treated is 50% or more.

6. The water treatment unit according to claim 1, wherein
said cleaning device includes at least one of cleaning liquid supply means capable of supplying a cleaning liquid into said casing, ultrasonic wave supply means capable of supplying an ultrasonic wave to said separation membrane, and water flow/bubble flow supply means capable of supplying a water flow and/or a bubble flow to said separation membrane.

7. A water treatment apparatus that performs water treatment using a reverse osmosis membrane, comprising:
a first water treatment unit capable of performing pretreatment of water to be treated; and
a second water treatment unit capable of performing main treatment of the water to be treated,
said first water treatment unit including:
a casing;
a separation membrane mounted in said casing and bent into a pleated shape;
a reinforcing member attached to said separation membrane and having a function of reinforcing said separation membrane;
a rotating mechanism rotating said separation membrane; and
a cleaning device capable of cleaning said separation membrane, wherein
said separation membrane has a plurality of island-like portions and a plurality of fiber-like portions extending from said island-like portions and having a width smaller than that of said island-like portions, and an area of said fiber-like portions at a membrane surface is set to be larger than that of said island-like portions.
